(19) United States
(12) Patent Application Publication
(10) Pub. No.: US 2013/0092132 A1
(43) Pub. Date: Apr. 18, 2013

(54) METHOD FOR OPERATING AN INTERNAL COMBUSTION ENGINE

(71) Applicant: Rivener Musavirovich Gabdullin, Moscow (RU)

(72) Inventor: Rivener Musavirovich Gabdullin, Moscow (RU)

(21) Appl. No.: 13/640,316

(22) PCT Filed: Sep. 20, 2010
(86) PCT No.: PCT/RU2010/000457

§ 371 Date: Dec. 24, 2012

(30) Foreign Application Priority Data
Apr. 15, 2010 (RU) 2010115063

(51) Int. Cl. F02B 75/04

(52) U.S. Cl. CPC F02B 75/04
USPC 123/48 R

(57) ABSTRACT

The invention relates to engine building, and specifically to reciprocating internal combuston engines. The technical result of the invention consists in simplifying the design, the possibility of monitoring and regulating the moment of self-ignition of a homogenized fuel-air mix, and reducing the specific flow rate of the fuel. The method for operating an internal combustion engine consists in feeding a charge to the combustion chamber of a main cylinder and an auxiliary cylinder which are connected to one another and have different diameters, and in which the pistons are arranged. The piston of the auxiliary cylinder is delayed in accordance with the shaft rotation phase with respect to the piston of the main cylinder and as the piston of the main cylinder reaches the upper dead center thereof, when the majority of the charge is located in the auxiliary cylinder, and the charge to the piston of the auxiliary cylinder is boosted. The piston of the main cylinder is used to compress the mix without bringing said mix to self-ignition and therefore preparing said mix for subsequent rapid ignition, while the piston of the auxiliary cylinder is used to boost the compressed homogenized fuel-air mix, and said mix is brought to the temperature and pressure in the combustion chamber prior to compression self-ignition of the mix.

### FIELD OF TECHNOLOGY

The invention relates to engine design, specifically, to reciprocating internal combustion engines.

### PRIOR ART

There is known a twin reciprocating internal combustion engine (RF patent No. 2078963 of 7 Jun. 1994) containing two cylinders with a common combustion chamber, two crankshafts joined to each other by a 1:2 transmission, and when one piston is at its upper dead center the other is advanced by 45 angular degrees, or close to that, from its upper dead center. The working volumes of the cylinders are equal.

The known technical solution has a number of disadvantages:
the need to blow air through the combustion chamber after the exhaust stroke reduces the efficiency of the engine.
the engine cannot work with a homogenized fuel and air mixture in a compression ignition mode.
increasing the 1:2 transmission ratio between the shafts complicates the design and reduces its reliability.

The closest to the invention in technical essence is the internal combustion engine (USSR inventor's certificate No. 1229397 of 30 Jan. 1981), containing a main cylinder and an auxiliary cylinder of lesser volume with a common combustion chamber and pistons connected to individual crankshafts, kinematically connected to each other and shifted by 46-85° relative to each other by a rotation phase shift coupling, with ability to rotate at different frequency, while the shafts are kinematically linked together in a 1:2 ratio, and the volume of the auxiliary cylinder constitutes 5-10% of the main cylinder.

However, this solution also has disadvantages:
the engine works by compressing air to such a degree that the fuel sprayed into it is ignited, i.e., as a Diesel engine with a high degree of compression.
the presence of a reduction gear for the kinematic linkage of the shafts in a 1:2 ratio complicates the design of the engine and lowers its reliability.
the fuel and air mix is ignited by the compression of both pistons, which impairs the precise ignition of the fuel and air mixture by compression at the u.d.c. of the main piston.
the engine is not able to work with a homogenized fuel and air mixture in a compression ignition mode.

The problem to be solved by the present invention is the ability to control and regulate the moment of self-ignition of a homogenized fuel and air mix.

### DISCLOSURE OF THE INVENTION

The technical result of the invention is to shift the point of transition of the change in overall volume of the combustion chambers, from an increase to a decrease and vice versa, from the position of the main piston at their u.d.c. and l.d.c., to simplify the design, to reduce the specific fuel consumption, and to improve the ecological characteristics of the engine.

This problem is solved, and the technical result is achieved, in that, with the method for operating an internal combustion engine, including the feeding of a charge to the combustion chambers of the main and auxiliary cylinders, joined together and having different diameters, in which pistons are located, compression of the change by the pistons in both cylinders, while the piston of the auxiliary cylinder is delayed in shaft rotation phase from the piston of the main cylinder, and after the piston of the main cylinder reaches its upper dead center, boosting of the charge by the piston of the auxiliary cylinder, according to the invention, a homogenized fuel and air mix is fed to the cylinders, compressed by the two pistons, while the piston of the main cylinder compresses the mix without allowing it to self-ignite and thus preparing it for the subsequent rapid ignition, while the piston of the auxiliary cylinder boosts the compressed homogenized fuel and air mix, bringing its temperature and pressure in the combustion chamber up to a compression self-ignition of the mixture.

The stated problem is also solved in that the volume of the chamber of the main cylinder above the piston is specified to be the least possible at the moment it is at its upper dead center.

The stated problem is also solved in that, after the start of the boosting of the homogenized fuel and air mix by the piston of the auxiliary cylinder, fuel of different composition from that used to prepare the homogenized fuel and air mix is injected into the combustion chamber, for which the pressure and temperature are sufficient for its ignition.

The stated problem is also solved in that, after the start of the boosting of the homogenized fuel and air mix by the piston of the auxiliary cylinder, fuel of different composition from that used to prepare the homogenized fuel and air mix is injected into the combustion chamber, and it is forced to ignite by a spark plug.

The stated problem is also solved in that an injector plug is used with its own micro-combustion chamber to which fuel is supplied in the intake stroke that differs in composition from that used for preparation of the homogenized fuel and air mix, and it is forced to ignite at the start of the working movement.

The stated problem is also solved in that an enriched homogenized fuel and air charge is supplied to the combustion chamber, using fuel of different composition from that used to prepare the homogenized fuel and air mix, which is forced to ignite by the spark plug.

The stated problem is also solved in that, after the compression self-ignition of the homogenized fuel and air mix, an additional portion of fuel is injected into the combustion chamber.

The stated problem is also solved in that the angular value of lagging of the rotation of the auxiliary cylinder's piston shaft rotation behind the shaft of the main cylinder's piston is set in the range of up to 120° and this value is regulated by a relative shift in the rotation phases of the shafts.

The stated problem is also solved in that the moment of self-ignition of the homogenized fuel and air mix is further regulated by changing the moment of closing of the exhaust shutoff element.

The stated problem is also solved in that the moment of self-ignition of the homogenized fuel and air mix is further regulated by changing the degree of boosting.

The stated problem is also solved in that the piston stroke of the auxiliary cylinder is different from the piston stroke of the main cylinder.

The stated problem is also solved in that the main and auxiliary piston(s) are mounted on different non-coaxial shafts, kinematically linked to each other and turning at identical frequency.

The stated problem is also solved in that the pistons of the main and auxiliary cylinder are mounted with a fixed value of displacement of one piston relative to the other.

### BRIEF DESCRIPTION OF THE DRAWINGS

FIG. 1 shows a diagram of the engine being specified;

FIGS. 2-13 show the mutual arrangement of the pistons in different stages of the working cycle;

FIG. 14 shows an engine with different piston stroke lengths;

FIG. 15 is the same, a variant arrangement of the injector, spark plug, injection and exhaust valves.

### PREFERRED EMBODIMENT OF THE INVENTION

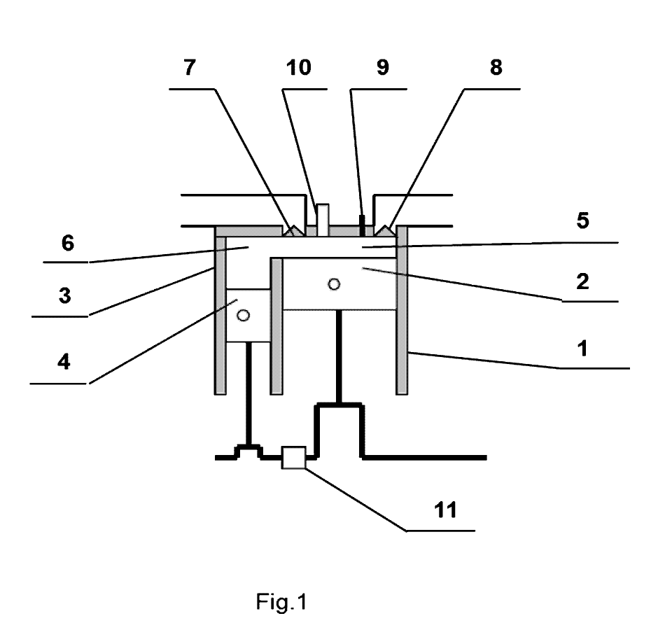

The invention being specified is realized in an internal combustion engine (FIG. 1) composed of a main cylinder 1, inside which there is a main piston 2, and an auxiliary cylinder 3, inside which there is an auxiliary piston 4. The main piston 2 and the main cylinder 1 form the combustion chamber 5, while the auxiliary piston 4 and auxiliary cylinder 3 form the combustion chamber 6, which are joined together and form a common combustion chamber in the upper part of the cylinders 1 and 3. In the common combustion chamber are installed the admission shutoff element 7, the exhaust shutoff element 8, the injector 9 and the spark plug 10. The crankshafts of both pistons are joined together by a rotation phase shift mechanism 11. Thanks to the presence of the auxiliary piston 4, whose crankshaft lags in rotation phase behind the crankshaft of the main piston, the points of transition of the change in overall volume of the combustion chambers 5 and 6, from increase to decrease and vice versa, do not coincide with the positions of the main piston at their u.d.c. and l.d.c., but lag behind by a calculated value, determined by the angular value of the positions of both crankshafts relative to each other.

The drawing (FIG. 1) shows diagrams of all parts and subassemblies of the engine needed to understand the principles of the operating method for the engine. The longitudinal section drawings show the main working processes of the internal combustion engine, but do not show the crank mechanisms with the shafts, but only the positions of both pistons at the particular moment of operation of the engine. The directions of movement of the valves and pistons are shown by arrows, the tips of the arrows being omitted at the moment when both pistons are at their upper and lower dead centers. The injector plug is not shown separately.

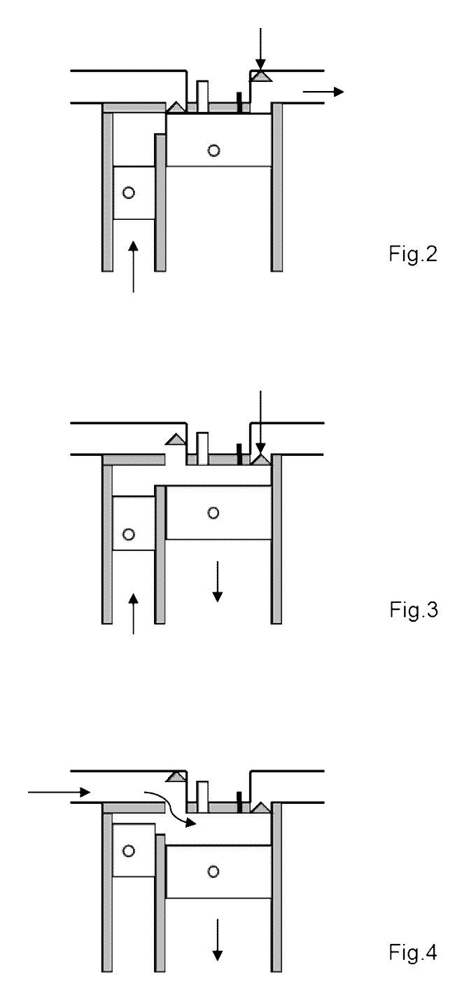

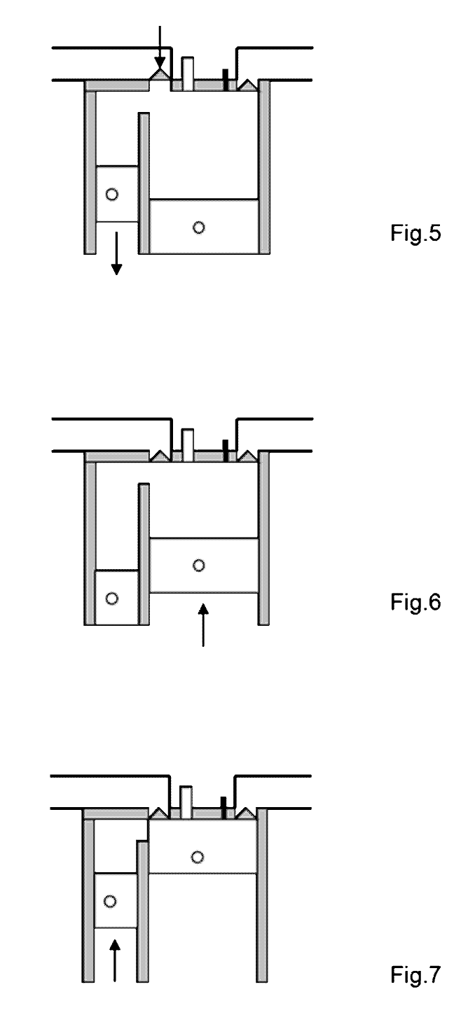

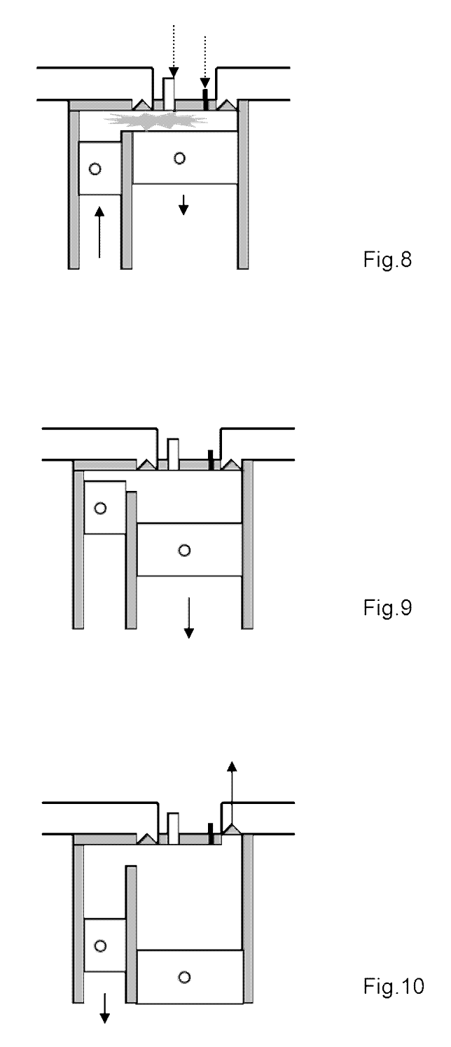

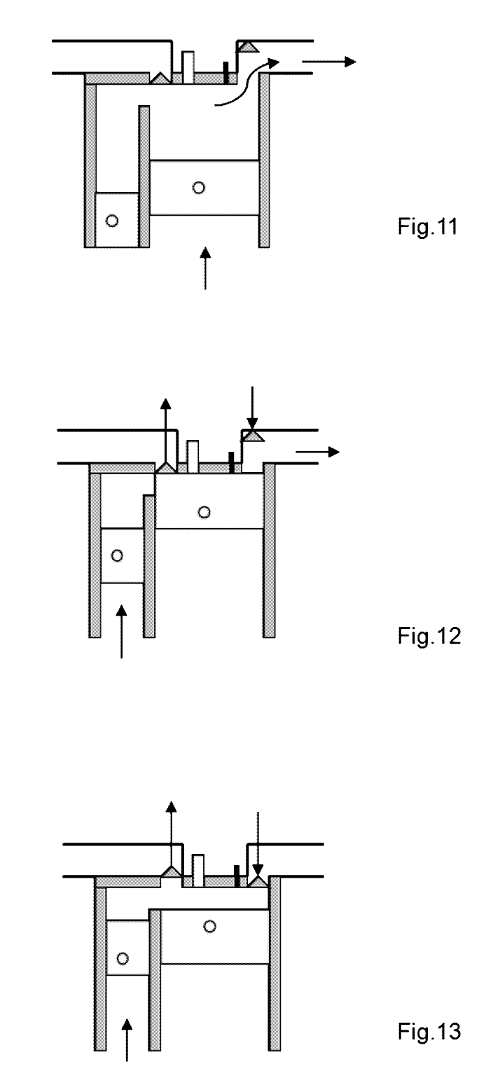

The engine works as follows. At the start of the working of the internal combustion engine, the main piston 2 is at its u.d.c. (FIG. 2), forming the minimally possible design volume of the combustion chamber 5, while the auxiliary piston 4, lagging behind the main piston 2 in rotation phase, moves to its u.d.c. The exhaust shutoff element 8 is open for exhaust of the remnants of spent gases of the previous cycle from the common combustion chamber. As the main piston 2 moves from the u.d.c. downward and the auxiliary piston 4 continues to move upward, the linear speed of the start of movement of the main piston 2 begins to rise from the zero mark, at the same time as the speed of the auxiliary piston 4 greatly surpasses the speed of the main piston 2; this results, at first, in a decrease in the overall volume of the combustion chambers 5 and 6, and then, after passing through the upper dead center, to an increase thereof The exhaust shutoff element 8 closes, the admission shutoff element 7 opens, and homogenized fuel and air mix begins to be supplied to the expanding common combustion chamber (FIG. 3). If it is necessary to leave behind a portion of the spent gases in the common combustion chamber, it is advisable to close the exhaust shutoff element 8 earlier, before the volume of the common combustion chamber starts to increase. Upon reaching its u.d.c., the auxiliary piston 4 reverses its movement vector (FIG. 4). When the main piston 2 reaches its l.d.c. (FIG. 5), the auxiliary piston 4 continues its downward movement. The linear speed of the start of movement of the main piston 2 begins to rise from the zero mark, while the speed of the auxiliary piston 4 greatly surpasses the speed of the main piston 2; this results, at first, in an increase in the overall volume of the combustion chambers 5 and 6, and then, after passing through the lower dead center, to an decrease thereof The admission shutoff element 7 closes at the start of the decrease in the overall volume and the supply of homogenized fuel and air mix ceases. As the main piston 2 moves upward, compression of the charge of homogenized fuel and air mix begins at first by the main piston 2, and then also by the auxiliary piston 4, after it passes through its lower dead center (FIG. 6). The volume of the common combustion chamber is chosen such that, when the main piston 2 reaches its u.d.c., the compressed homogenized fuel and air mix has a temperature close to the self-ignition point, but has not yet reached it (FIG. 7). When the main piston 2 is at its u.d.c., its working surface and the lid of the main cylinder form the minimally possible design volume of the combustion chamber 6, having concentrated the entire charge of compressed homogenized fuel and air mix in the combustion chamber 5, where the auxiliary piston 4 continues to boost the homogenized fuel and air mix. Given once again that the linear speed of the start of movement of the main piston 2 begins to increase from the zero mark, while the speed of the auxiliary piston 4 greatly surpasses the speed of the main piston 2, and the upper point of transition of the change in overall volume of the combustion chambers 5 and 6, from a decrease to an increase, has not yet been reached, this results in a further boosting of the homogenized fuel and air mix and rapid reaching of the temperature of volumetric self-ignition of the homogenized fuel and air mixture (FIG. 8). (For example, if the shaft rotation phase shift is equal to 90 angular degrees, then when the main piston 2 is at its u.d.c. the linear speed of the auxiliary piston 4 at this moment will be a maximum.) The high pressure of the burning gases at the same time acts on the working surfaces of the main piston 2, which has begun its movement from its u.d.c., and the auxiliary piston 4, not yet having reached its u.d.c. Since the area of the main piston 2 is several times greater than the area of the auxiliary piston 4, the force of pressure on the main piston 2 is that much greater than the force of pressure on the auxiliary piston 4. This means that the main piston 2 will perform its working stroke, while the auxiliary piston 4 is forced to continue its movement to its u.d.c. with back pressure from the burning gases. In addition, the inertia of the turning shaft of the engine will help the auxiliary piston 4 overcome the pressure of the burning gases. Upon reaching its u.d.c., the auxiliary piston 4 reverses the vector of its movement (FIG. 9) and also begins to execute its working stroke under the action of the excess pressure of the burning gases. If the energy of the charge of homogenized fuel and air mix is used up, and it is necessary to obtain greater power from the engine, then after the compression self-ignition or upon the auxiliary piston 4 reaching its u.d.c. the injector 9 injects fuel into the common combustion chamber with the burning gases, and it is ignited by them (FIG. 8). The main piston 2, arriving at its l.d.c., will finish the working stroke. (FIG. 10). At this time, the exhaust shutoff element 9 opens and, as the main piston 2 moves upward, the spent gases are led outside from the common combustion chamber (FIG. 11). The residual pressure of burning gases will assist the auxiliary piston 4 in completing the working stroke, and after passing through its l.d.c. it will also work to remove spent gases from the common combustion chamber (FIG. 12). The main piston 2, having completed the exhausting of spent gases, is in its u.d.c. At this time or somewhat later, depending on the engine operating duty, the exhaust shutoff element 8 is closed (FIG. 13). After its closure, one cycle is completed and the next one begins.

The foregoing applies to an engine that is warmed up. The following variants are proposed for starting a cold engine:

1) After the start of boosting of the homogenized fuel and air mixture by the auxiliary piston 4, the injector 9 sprays a microportion of a highly flammable fuel, such as ether, into the common combustion chamber, for which the temperature and pressure achieved in the combustion chamber are sufficient for its ignition. This leads to an even greater increase in the pressure and temperature from the burning gases which, in turn, leads to the compression self-ignition of the compressed homogenized fuel and air mix. After the required warm-up of the engine, the injection of highly flammable fuel ceases.

2) After the start of boosting of the homogenized fuel and air mix by the auxiliary piston 4, the injector 9 sprays a microportion of a highly evaporative fuel, such as gasoline, into the common combustion chamber, and this is forced to ignite by the spark plug 10, which leads to an even greater increase in the pressure and temperature from the burning gases which, in turn, leads to the compression self-ignition of the compressed homogenized fuel and air mix. Since a microportion of fuel is being injected, its spray occurs in the zone of location of the spark plug 10 or directly at its electrodes. One can use an injector plug with its own micro-ignition chamber, such as is described in the U.S. Pat. Nos. 5,109,817 and 5,271,365. In this case, the injection of the microportion of fuel can be done in the intake stroke, making use of a low-pressure fuel pump or carburetor. An enriched fuel and air mix is obtained in the microchamber, which is forced to ignite at the start of the working stroke. The combustion products with high values of pressure and temperature and free radicals go through valves into the impoverished fuel and air mix, which is self-ignited by compression in the combustion chamber. After the required warm-up of the engine, the injection of highly evaporative fuel ceases.

In both of the above instances, the microportions of the other fuel are a regulated donator for initiating compressive self-ignition of the homogenized fuel and air mix with the main fuel.

3) Prior to intake of the homogenized fuel and air mix into the common combustion chamber, instead of the main fuel, such as Diesel, to create the homogenized fuel and air mix, one uses another highly evaporative fuel, such as gasoline, and the mixture is made to be lean; this is supplied to the combustion chamber, compressed, and forcibly ignited by the spark plug 10. After the necessary warm-up of the engine, one switches to the main fuel for preparation of the homogenized fuel and air mix.

In this variant, the main fuel is replaced by another one.

4) Prior to starting of the engine in which Diesel fuel is used as the main fuel, one sets the angular value of the lag of the piston shaft rotation of the auxiliary cylinder behind the piston shaft of the main cylinder equal to 0°, for a synchronized working of both pistons in the same phase. In the intake stroke, air is supplied to the engine. The volume of the combustion chamber of the auxiliary cylinder above the piston at the moment it is in its upper dead center position is accordingly equal to the volume of the combustion chamber of the Diesel engine at the moment its piston is at its upper dead center, with cross sectional area of the piston equal to the sum of cross sectional areas of the main and auxiliary pistons. The proposed engine is started like an ordinary Diesel engine with fuel injection into compressed air in the combustion chamber of the auxiliary cylinder. After the starting and warm-up of the engine, the angular value of the lag of shaft rotation of the auxiliary piston behind the shaft of the main piston is set in accordance with the required operating duty of the engine.

In this variant, both pistons work synchronized as one, and the engine works like an ordinary Diesel engine.

In the warmed-up engine, as one variant to obtain additional power, after the compressive self-ignition of the homogenized fuel and air mix one injects an additional portion of fuel into the combustion chamber with the burning gases.
In the warmed-up engine, as another variant to obtain additional power, after the compressive self-ignition of the homogenized fuel and air mix one adjusts the angular value of the lag of the shaft rotation of the auxiliary piston behind the shaft of the main piston equal to 0°, so that both pistons work synchronized in the same phase, while the engine itself is adjusted to the working duty of an ordinary Diesel engine.

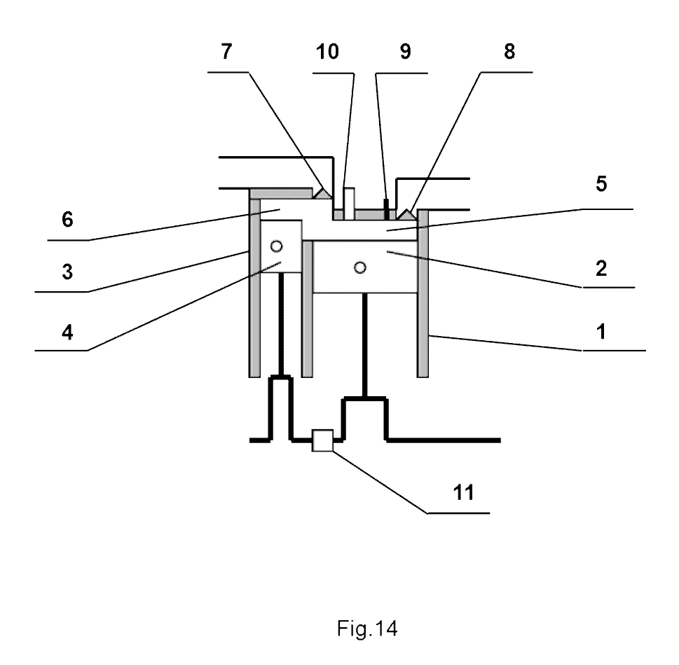

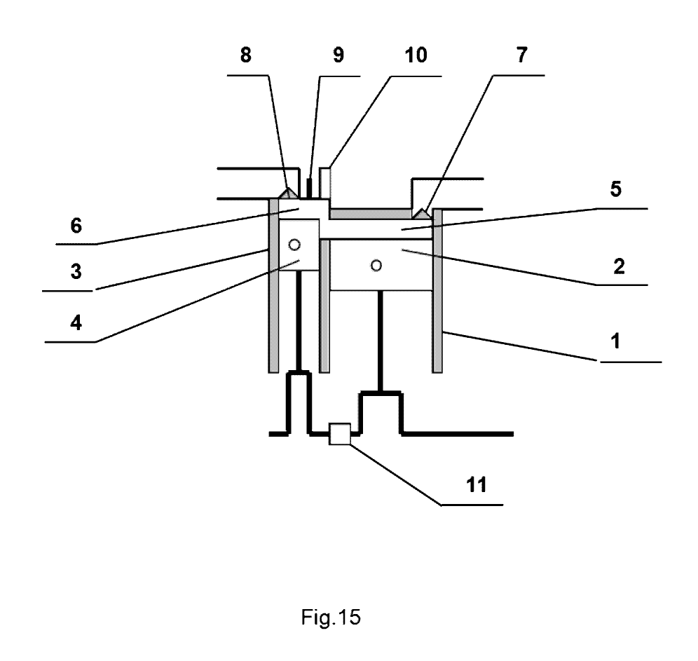

FIG. 14 shows an engine with different lengths of piston strokes, and FIG. 15 shows another variant for the arrangement of injector, plug, admission and exhaust valves. The ratio of diameters and lengths of the piston strokes, and also the size of the angle of delay of the auxiliary piston relative to the main one, is chosen by calculation and trial and error. The size of the angle of delay of the auxiliary piston relative to the main one can be chosen and regulated by the rotation phase shift mechanism from 0 to 120 angular degrees, depending on the working duty of the engine. To simplify the engine design, the main and auxiliary pistons can be mounted on the same shaft with a fixed displacement of the rotation phases of the shafts. Furthermore, the moment of self-ignition of the mixture can be additionally regulated by the moment of closing of the exhaust shutoff element to hold up a portion of the spent gases in the cylinder, and also by the use of a turbocharger.

### INDUSTRIAL APPLICABILITY

The proposed internal combustion engine can operate on various types of fuels with the aforementioned possibilities for its regulation.

1. A method for operating an internal combustion engine, comprising the feeding of a charge to the combustion chambers of the main and auxiliary cylinders, joined together and having different diameters, in which pistons are located, compression of the change by the pistons in both cylinders, while the piston of the auxiliary cylinder is delayed in shaft rotation phase from the piston of the main cylinder, and after the piston of the main cylinder reaches its upper dead center, the charge is boosted by the piston of the auxiliary cylinder, characterized in that a homogenized fuel and air mix is fed to the cylinders and compressed by the two pistons, while the piston of the main cylinder compresses the mix without allowing it to self-ignite and thus preparing it for the subsequent rapid ignition, while the piston of the auxiliary cylinder boosts the compressed homogenized fuel and air mix, bringing its temperature and pressure in the combustion chamber up to a compression self-ignition of the mixture.

2. The method according to claim 1, characterized in that the volume of the chamber of the main cylinder above the piston is specified to be the least possible at the moment it is at its upper dead center.

3. The method according to claim 1, characterized in that, after the start of boosting the homogenized fuel and air mix by the piston of the auxiliary cylinder, fuel of different composition from that used to prepare the homogenized fuel and air mix is injected into the combustion chamber, for which the pressure and temperature are sufficient for its ignition.

4. The method according to claim 1, characterized in that, after the start of boosting the homogenized fuel and air mix by the piston of the auxiliary cylinder, fuel of different composition from that used to prepare the homogenized fuel and air mix is injected into the combustion chamber, and it is forced to ignite by a spark plug.

5. The method according to claim 4, characterized in that an injector plug is used with its own micro-combustion chamber to which fuel is supplied in the intake stroke that differs in composition from that used for the preparation of the homogenized fuel and air mix, and it is forced to ignite at the start of the working movement.

6. The method according to claim 1, characterized in that an enriched homogenized fuel and air charge is supplied to the combustion chamber, using fuel of a different composition from that used to prepare the homogenized fuel and air mix, which is forced to ignite by the spark plug.

7. The method according to claim 1, characterized in that, after the compression self-ignition of the homogenized fuel and air mix, an additional portion of fuel is injected into the combustion chamber.

8. The method according to claim 1, characterized in that the angular value of lagging of the rotation of the auxiliary cylinder's piston shaft rotation behind the shaft of the main cylinder's piston is set in the range of up to 120° and this value is regulated by a relative shift in the rotation phases of the shafts.

9. The method according to claim 1, characterized in that the moment of self-ignition of the homogenized fuel and air mix is further regulated by changing the moment of closing of the exhaust shutoff element.

10. The method according to claim 1, characterized in that the moment of self-ignition of the homogenized fuel and air mix is further regulated by changing the degree of boosting.

11. The method according to claim 1, characterized in that the piston stroke of the auxiliary cylinder is different from the piston stroke of the main cylinder.

12. The method according to claim 1, characterized in that the main and auxiliary piston(s) are mounted on different non-coaxial shafts, kinematically linked to each other and turning at identical frequency.

13. The method according to claim 1, characterized in that the pistons of the main and auxiliary cylinder are mounted with a fixed value of displacement of one piston relative to the other.
